(19) United States
(12) Patent Application Publication
(10) Pub. No.: US 2010/0138486 A1
(43) Pub. Date: Jun. 3, 2010

(54) SWITCHING METHOD, APPARATUS, AND SYSTEM FOR MEDIA SOURCE

(75) Inventors: Jian Yang, Shenzhen (CN); Guoqiao Chen, Shenzhen (CN); Lei Wang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/697,416

(22) Filed: Feb. 1, 2010

Related U.S. Application Data
(63) Continuation of application No. PCT/CN2008/071836, filed on Jul. 31, 2008.

(30) Foreign Application Priority Data
Aug. 1, 2007 (CN) 200710143459.7

(51) Int. Cl. G06F 15/16

(52) U.S. Cl. 709/203; 709/227; 709/230

(57) ABSTRACT

A fast switching method for media source includes: receiving, by a multimedia server, request information for performing media source switching from a user equipment; and switching, by the multimedia server, a current media source to a target media source requested by the user equipment according to the request information, and delivering the target media source to the user equipment through a current session and media communication channel resources. In the present invention, after the user equipment sends the request information for performing media source switching to the multimedia server, the current session and the media communication channel resources between the multimedia server and the user equipment are not released, and the multimedia server delivers the target media source requested by the user equipment through the current session and the media communication channel resources. Therefore, the time taken by the media source switching operation is greatly reduced, thus solving the problem in the conventional art that the user has to wait for a long time when performing the media source switching operation

### CROSS-REFERENCE TO RELATED APPLICATIONS

This application is a continuation of International Patent Application No. PCT/CN2008/071836 filed Jul. 31, 2008, which claims priority to Chinese Patent Application No. 200710143459.7, filed Aug. 1, 2007, both of which are hereby incorporated by reference in their entireties.

### FIELD OF THE INVENTION

The present invention relates to the field of communications technology, and more particularly, to a fast switching method, apparatus, and system for media source.

### BACKGROUND

Along with the development of computer networks and the ever increasing requirements of people for information diversity, the application of multimedia technology becomes more and more popular. In a broad sense, the multimedia technology is a general term of a series of technologies, methods, and protocols for forming audio and video into stable and continuous transmission streams and playback streams. In a narrow sense, the multimedia technology only refers to a new technology adapted to issue multimedia data streams on an Internet Protocol (IP) network. Different from the conventional playback technology, the multimedia technology adopts a streaming transmission mode. That is, the whole multimedia file is divided into several compressed packets through a special compression method, and a video server sends the compressed packets to a user computer continuously and in real time, so the user may decompress and play back the packets sent previously while downloading the subsequent packets without waiting for the completion of the downloading. Therefore, the start delay is significantly reduced, and the demand for the buffer capacity of the system is greatly reduced as well.

The multimedia refers to a media format for playing in the Internet through streaming transmission. The implementation of streaming transmission needs an appropriate transport protocol, and currently, the protocols supporting the multimedia transmission mainly include a Real-time Transport Protocol (RTP), a Real-time Transport Control Protocol (RTCP), a Real-time Streaming Protocol (RTSP), and a Resource Reserve Protocol (RSVP).

The RTSP is jointly proposed by Real Networks and Netscape, and this protocol defines how a pair of multi-application programs effectively transmits multimedia data through the IP network. In the architecture, the RTSP runs on top of the RTP and RTCP, and finishes the data transmission through Transmission Control Protocol (TCP) or RTP. Compared with Hypertext Transfer Protocol (HTTP), the HTTP transmits Hypertext Markup Language (HTML), while the RTP transmits the multimedia data. An HTTP request is sent by a user equipment, and responded to by a server; when using the RTSP, both the user equipment and the server can send a request, so the RTSP may be bi-directional. The RTSP protocol is an application-level protocol for control over the delivery of multimedia data with real-time properties. The RTSP provides an extensible framework to enable controlled, on-demand delivery of real-time data (such as audio and video). Sources of data can include both live data feeds and stored clips. This protocol is intended to control multiple data delivery sessions, provide a means for choosing delivery channels such as User Datagram Protocol (UDP), multicast UDP and TCP, and provide a means for choosing delivery mechanisms based upon RTP. The RTSP may establish and control either a single or several time-synchronized streams of continuous media. The protocol does not typically deliver the continuous streams, although interleaving of the continuous media stream with the control stream is possible. In other words, the RTSP acts as a “network remote control” for multimedia servers.

In the conventional art, the multimedia is mainly implemented by finishing the control over the multimedia through the RTSP protocol, and finishing the delivery of the media stream through the RTP/RTCP protocol. In the RTSP protocol, the function of session establishment is finished through Describe and Setup methods, and the function of multimedia session control is performed through Play, Pause, and Teardown methods. A multimedia session process mainly includes multimedia discovery, multimedia session establishment, media session control, media transport resource establishment, and other processes. The session establishment process takes a period of time, that is to say, it takes some time for the user to normally view the multimedia after finding the multimedia. If the user wants to perform multimedia source switching during the playback of the multimedia, the current session needs to be torn down to release the current session and media communication channel resources, and reestablish a new session with the multimedia server. This means that a lengthy switching process is taken to release the current session resources and reestablish the new session. Therefore, the time taken by the media source switching operation is rather long.

During the implementation of the present invention, the inventor found that the conventional art at least has the following problems.

The user has to wait for a long time when performing media source switching, resulting in a poor user experience.

### SUMMARY OF THE INVENTION

Accordingly, the present invention is directed to a fast switching method, apparatus, and system for media source, so as to solve the problem in the conventional art that the user has to wait for a long time when performing the media source switching operation.

In order to achieve the above objective, the present invention provides a fast switching method for media source, which includes the following steps: a multimedia server receives request information for performing media source switching from a user equipment; the multimedia server switches a current media source to a target media source requested by the user equipment according to the request information; and delivers the target media source to the user equipment through the current session and media communication channel resources.

The present invention further provides a fast switching system for media source, which includes a multimedia server and a user equipment. The user equipment is adapted to generate request information for performing media source switching, and send the request information to the multimedia server. The multimedia server is adapted to switch a current media source to a target media source requested by the user equipment according to the request information, and deliver the target media source to the user equipment through a current session and media communication channel resources.

The present invention further provides a multimedia server, which includes a request receiving module, a media source switching module, and a media source information delivering module. The request receiving module is adapted to receive request information for performing media source switching from a user equipment. The media source switching module is adapted to switch a current media source to a target media source requested by the user equipment according to the request information received by the request receiving module. The media source information delivering module is adapted to deliver the target media source switched by the media source switching module to the user equipment through a current session and media communication channel resources.

The present invention further provides a user equipment, which includes a request generating module and a request sending module. The request generating module is adapted to generate request information for performing media source switching of the user equipment by constructing an operation header field through an RTSP protocol. The request sending module is adapted to send the request information generated by the request generating module to a multimedia server.

Compared with the conventional art, the present invention has the following advantages.

In the present invention, after the user equipment sends the request information for performing media source switching to the multimedia server, the current session and the media communication channel resources between the multimedia server and the user equipment are not released, and the multimedia server delivers the target media source requested by the user equipment through the current session and the media communication channel resources, so that the time taken by the media source switching operation of the user equipment is greatly reduced, and thus the user experience is improved.

### BRIEF DESCRIPTION OF THE DRAWINGS

FIG. 1 is a structural view of a fast switching system for media source according the present invention;

FIG. 2 is a flow chart of a fast switching method for media source according to the present invention;

FIG. 3 is a flow chart of a fast switching method for media source according to a first embodiment of the present invention; and

FIG. 4 is a flow chart of a fast switching method for media source according to a second embodiment of the present invention.

### DETAILED DESCRIPTION OF THE EMBODIMENTS

The present invention provides a fast switching method, system, and apparatus for media source. In the present invention, a user equipment sends request information for performing media source switching to a multimedia server; and the multimedia server switches a current media source to a target media source requested by the user equipment according to the request information of the user equipment, and meanwhile reserves a current session and media communication channel resources between the multimedia server and the user equipment, and delivers the target media source requested by the user equipment through the current session and the media communication channel resources between the multimedia server and the user equipment. Through the present invention, the time taken by the user equipment to establish a session with the multimedia server and release and reestablish the media communication channel resources is saved, so that the time taken by the media source switching operation of the user equipment is greatly reduced, and thus the user experience is improved.

FIG. 1 is a structural view of a fast switching system for media source according to the present invention. Referring to FIG. 1, the system includes a multimedia server 1 and a user equipment 2. The multimedia server 1 receives request information for performing media source switching from the user equipment 2 and then determines whether the request information is valid or not. The method for determining whether the request information is valid or not may include: determining whether a current session corresponding to the request information exists or not, determining whether a target media source requested to be switched to exists or not, or determining whether a necessary parameter of the target media source is valid or not. If it is determined that the request information is valid, the multimedia server 1 switches a current media source to a target media source requested by the user equipment 2 according to the request information, and meanwhile reserves a session and media communication channel resources between the multimedia server 1 and the user equipment 2, and delivers the target media source requested by the user equipment 2 to the user equipment 2 through the current session and the media communication channel resources. If the multimedia server 1 determines that the request information is invalid, the multimedia server 1 returns the request. The user equipment 2 is adapted to generate the request information for performing media source switching, and deliver the request information to the multimedia server 1 through an RTSP protocol. After the request information is determined by the multimedia server 1 as valid, the user equipment 2 receives and plays back content of the target media source delivered by the multimedia server 1.

The multimedia server 1 includes a request receiving module 11, a media source switching module 13, and a media source information delivering module 14. The request receiving module 11 is adapted to receive the request information for performing media source switching sent by the user equipment 2. The request information includes an address or media flag of the target media source that the user equipment 2 requests to switch to, for example, a media flag representing a previous channel or a next channel. The media source switching module 13 is adapted to switch the current media source to the target media source requested by the user equipment 2 according to the request information after a request determining module 12 determines that the request information is valid, and reserves the current session and the media communication channel resources between the multimedia server 1 and the user equipment 2. The media source information delivering module 14 is adapted to deliver the target media source requested by the user equipment 2 to the user equipment 2 through the current session and the media communication channel resources.

Preferably, the multimedia server 1 further includes a request determining module 12, which is adapted to determine whether the request information received by the request receiving module 11 is valid or not. The method for determining whether the request information is valid or not may include: determining whether the current session corresponding to the request information exists or not, determining whether the target media source requested to be switched to exists or not, or determining whether a necessary parameter of the target media source is valid or not. If the request determining module 12 determines that the request information is invalid, the multimedia server 1 returns the request. For example, if the request determining module 12 determines that the target media source requested to be switched to in the request information does not exist, the multimedia server 1 returns the request to the user equipment 2.

The request determining module 12 includes a current session determining sub-module 121, which is adapted to determine whether the current corresponding to the request information exists or not, and if yes, the multimedia server 1 proceeds to the next operation; otherwise, the multimedia server 1 returns the request.

Preferably, the request determining module 12 further includes a target media source determining sub-module 122, which is adapted to determine whether the target media source that the user equipment 2 requests to switch to exists or not, and determine whether a necessary parameter of the target media source is valid or not. The necessary parameter includes an address or media flag of the target media source requested to be switched to, for example, a media flag representing a previous channel or a next channel. If the target media source exists and the necessary parameter is valid, the multimedia server 1 proceeds to the next operation, and if the target media source does not exist or the necessary parameter thereof is invalid, the multimedia server 1 returns the request.

The user equipment 2 includes a request generating module 21, a request sending module 22, and a media source content playback module 23. The request generating module 21 is adapted to generate request information for performing media source switching when the user performs the media source switching operation. The request information uses an operation flag header field constructed through the RTSP protocol to represent that the user is performing the media source switching operation, and meanwhile carries the address or media flag of the target media source requested to be switched to, for example, the media flag representing a previous channel or a next channel. The request sending module 22 is adapted to send the request information generated by the request generating module 21 to the multimedia server 1. The media source content playback module 23 is adapted to receive and play back the content of the target media source delivered by the multimedia server 1.

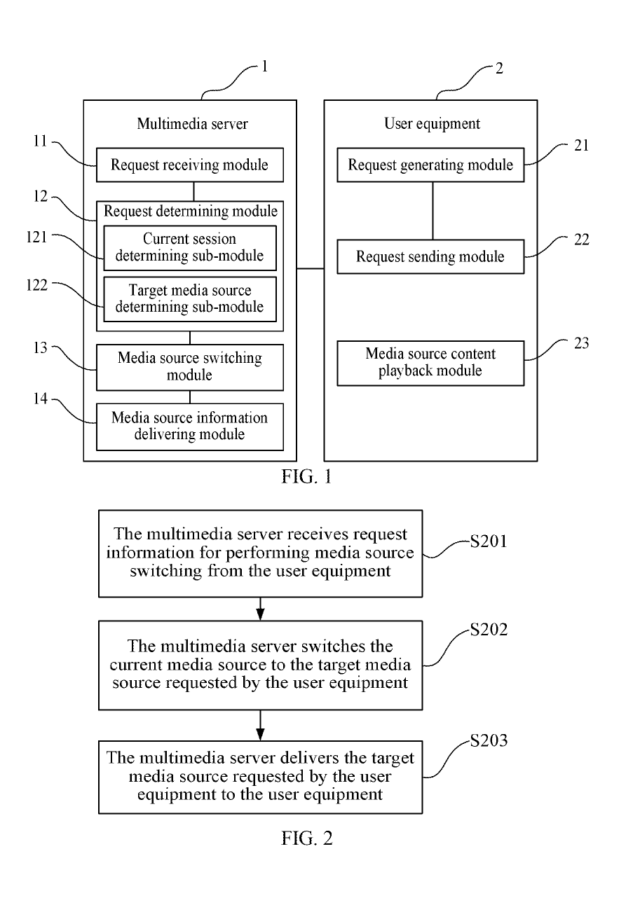

FIG. 2 is a flow chart of a fast switching method for media source according to the present invention. Referring to FIG. 2, the method includes the following steps.

In Step S201, a multimedia server receives request information for performing media source switching from a user equipment. When the user performs the media source switching operation, the user equipment constructs an operation flag header field through the RTSP protocol to represent that the user is performing the media source switching operation, and meanwhile the request information carries an address or media flag of a target media source requested to be switched to, for example, a media flag representing a previously channel or a next channel. The user equipment sends the generated request information to the multimedia server.

In Step S202, the multimedia server switches a current media source to a target media source requested by the user equipment. After receiving the request information for performing media source switching sent by the user equipment, the multimedia server first determines whether the request information is valid or not. The method for determining whether the request information is valid or not may include: determining whether the current session corresponding to the request information is valid or not, determining whether the target media source requested to be switched to exists or not, or determining whether a necessary parameter of the target media source is valid or not. If the multimedia server determines that the request information is valid, the multimedia server switches the current media source to the target media source requested by the user equipment according to the request information. If the multimedia server determines that the request information is invalid, the multimedia server returns the request.

In Step S203, the multimedia server delivers the target media source requested by the user equipment to the user equipment. When the multimedia server receives the request information for performing media source switching sent by the user equipment, the multimedia server reserves, rather than releases, the current session and media communication channel resources between the multimedia server and the user equipment; and after the multimedia server determines that the request information is valid and switches the current media source to the target media source requested by the user equipment, the multimedia server delivers the target media source requested by the user equipment to the user equipment through the current session and the media communication channel resources.

The present invention realizes the fast switching operation for media sources. In the present invention, the user equipment sends the request information for performing media source switching to the multimedia server, and the multimedia server switches the current media source to the target media source requested by the user equipment according to the request information, and meanwhile reserves the current session and the media communication channel resources between the multimedia server and the user equipment, and delivers the target media source requested by the user equipment to the user equipment through the current session and the media communication channel resources between the multimedia server and the user equipment. Therefore, the time taken from the start of the media source switching operation of the user equipment to the success of the switching is much shorter than the time taken by the media source switching operation in the conventional art, thus improving the user experience.

The present invention is further described through specific embodiments and with reference to the accompanying drawings.

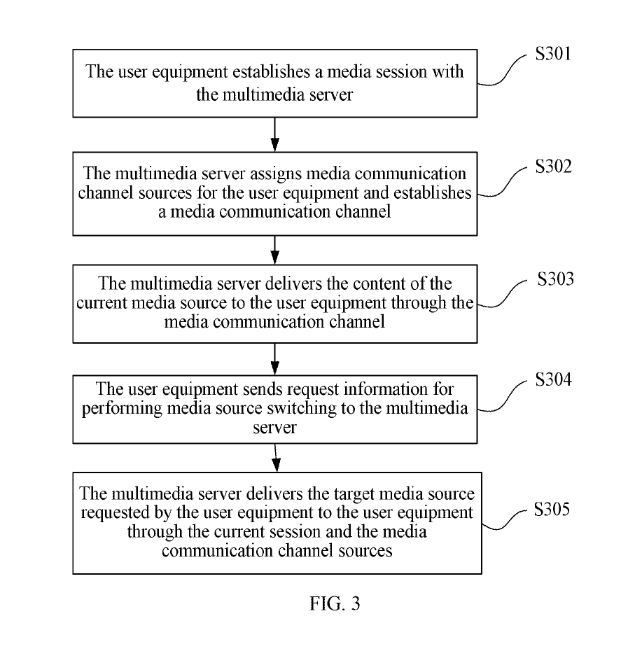

FIG. 3 is a flow chart of a fast switching method for media source according to a first embodiment of the present invention. Referring to FIG. 3, the method includes the following steps.

In Step S301, a user equipment establishes a normal media session with a multimedia server, requests to play back the content of a current media source. In the RTSP protocol, the media session between the user equipment and the multimedia server is established through a Describe method.

In Step S302, the multimedia server assigns media communication channel resources for the user equipment and establishes a media transport channel. In the RTSP protocol, the multimedia server assigns the media communication channel resources for the user equipment through a Setup method, so as to set up an RTSP connection.

In Step S303, the multimedia server delivers the content of the current media source through the media transport channel.

In Step S304, the user equipment sends request information for performing media source switching to the multimedia server. When the user performs the media source switching operation, the user equipment constructs an operation flag header field through the RTSP protocol to represent that the user is performing the media source switching operation, and meanwhile the request information carries an address or media flag of a target media source requested to be switched to, for example, a media flag representing a previous channel or a next channel.

For example, the manner of carrying an extension header field by using an Options method in the RTSP is as follows.

OPTIONS rtsp://audio.example.com/happy/audio1.en RTSP/1.0
Cseq:2
Session:12345678
Range:smpte = 0:10:00-
TagChannel: rtsp://audio.example.com/twister/audio21.en
(or TagChannel:Next)

The extension header field TagChannel indicates a uniform resource identifier (URI) of a new media requested by the user, and the value may be a specific URI, or a media flag representing a next or previous channel indicated by Next or Previous.

This extension header field may be carried through the Options method, or through a SET_PARAMETER method.

For example, the manner of carrying the extension header field by using the SET_PARAMETER method in the RTSP protocol is as follows.

SET_PARAMETER rtsp://audio.example.com/happy/audio1.en RTSP/1.0
Cseq:2
Session:12345678
Range:smpte = 0:10:00-
TagChannel: rtsp://audio.example.com/twister/audio21.en
(or TagChannel:Next)

In addition to the above two methods, this step may also be realized by an extension method in the RTSP. For example, the target media source that the user intends to switch to from the current media source is represented by using an EXCHANGE extension method, as shown below.

EXCHANGE rtsp://audio.example.com/happy/audio2.en RTSP/1.0
Cseq:2
Session:12345678
Range:smpte = 0:10:00-
or
EXCHANGE next RTSP/1.0
Cseq:2
Session:12345678
Range:smpte = 0:10:00-

In Step S305, the multimedia server delivers the target media source requested by the user equipment to the user equipment through the current session and the media communication channel resources. After the multimedia server receives the request information for performing media source switching sent by the user equipment, the multimedia server switches the current media source to the target media source requested by the user equipment, but does not release the current session and the media communication channel resources between the multimedia server and the user equipment, and then delivers the target media source requested by the user equipment to the user equipment through the current session and the media communication channel resources.

In the above fast switching method for media source, the user equipment generates the request information for performing media source switching by using the Options method, SET_PARAMETER method, and RTSP extension method in the RTSP protocol, and then sends the request information to the multimedia server; and the multimedia server switches the current media source to the target media source requested by the user equipment according to the request information, and delivers the target media source through the current session and the media communication channel resources, so that the time for releasing and reestablishing the session and the media communication channel resources between the user equipment and the multimedia server is saved.

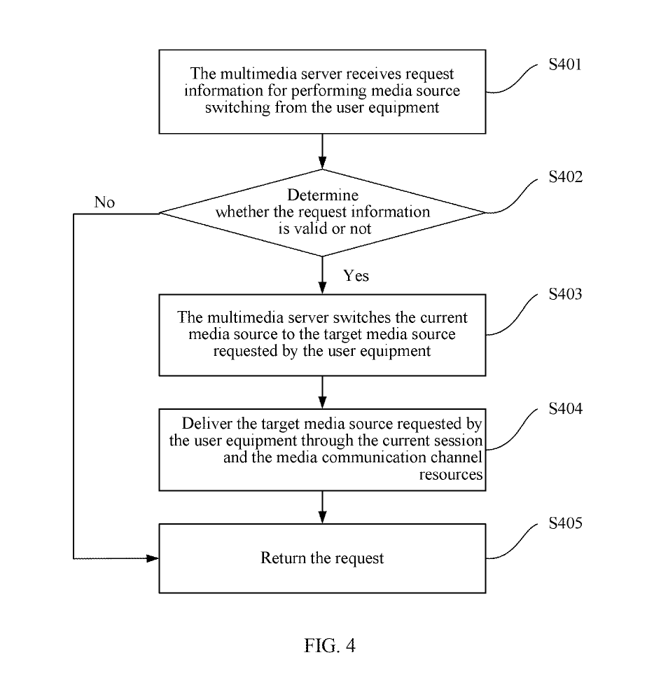

FIG. 4 is a flow chart of a fast switching method for media source according to a second embodiment of the present invention. Referring to FIG. 4, after a multimedia server receives request information for performing media source switching sent by a user equipment, the procedure of processing the request information includes the following steps.

In Step S401, the multimedia server receives the request information for performing media source switching sent by the user equipment. The request information includes an address or media flag of a target media source that the user equipment requests to switch to, for example, a media flag representing a previous channel or a next channel.

In Step S402, the multimedia server determines whether the received request information is valid or not. The method for determining whether the received request information is valid or not may include: determining whether a current session corresponding to the request information exists or not, determining whether the target media source requested to be switched to exists or not, or determining whether necessary parameter of the target media source is valid or not. If the multimedia server determines that the request information is valid, the procedure proceeds to Step S403; and if the multimedia server determines that the request information is invalid, the procedure proceeds to Step S405 to return the request.

In Step S403, the multimedia server switches a current media source to the target media source requested by the user equipment, but does not release the current session and media communication channel resources between the multimedia server and the user equipment.

In Step S404, the multimedia server delivers the target media source requested by the user equipment to the user equipment through the current session and the media communication channel resources.

In Step S405, the multimedia server returns the request.

In the fast switching method for media source according to the present invention, after the multimedia server receives the request information for performing media source switching sent by the user equipment, the multimedia server first determines whether the request information is valid or not, and if the request information is valid, the multimedia server switches the current media source to the target media source requested by the user equipment according to the request information, and delivers the target media source through the current session and the media communication channel resources, so that the time taken by the media source switching operation of the user equipment is greatly reduced, and thus the user experience is improved.

Through the above description in the detailed description, it is clear to those skilled in the art that the present invention may be accomplished through hardware, or through software plus necessary universal hardware platform. Base on this, the technical solutions of the present invention may be embodied in the form of a software product. The software product may be stored in one or more nonvolatile storage media (for example, CD-ROM, USB flash drive, or removable hard disk) and contain several instructions adapted to instruct a computer equipment (for example, a personal computer, a server, or a network equipment) to perform the method according to the embodiments of the present invention.

The above descriptions are merely preferred embodiments of the present invention, but not intend to limit the scope of the present invention. Any modification, equivalent replacement, and improvement made without departing from the spirit and principle of the present invention shall fall within the scope of the present invention.

What is claimed is:

1. A fast switching method for media source, comprising:
receiving, by a multimedia server, request information for performing media source switching from a user equipment;
switching, by the multimedia server, a current media source to a target media source requested by the user equipment according to the request information, and delivering the target media source to the user equipment through a current session and media communication channel resources.

2. The fast switching method for media source according to claim 1, wherein the request information comprises an address or media flag of the target media source.

3. The fast switching method for media source according to claim 2, wherein the address or media flag of the target media source is carried by an operation flag header field of the request information, and the operation flag header field is generated by the user equipment through a multimedia communication protocol.

4. The fast switching method for media source according to claim 1, after the receiving and before switching, by the multimedia server, the request information for performing media source switching from the user equipment, further comprising:
determining, by the multimedia server, whether the request information is valid or not;
wherein if the request information is valid, the multimedia server stops playing back the current media source according to the request information.

5. The fast switching method for media source according to claim 4, wherein the determining whether the request information is valid or not comprises: determining whether the current session corresponding to the request information exists or not, and the request information is determined as valid if the current session exists.

6. The fast switching method for media source according to claim 4, wherein the determining whether the request information is valid or not comprises: determining whether the target media source requested to be switched to exists or not, and the request information is determined as valid if the target media source exists.

7. The fast switching method for media source according to claim 3, wherein the multimedia communication protocol at least comprises:
a real-time multimedia protocol, a session description protocol (SDP), a session initiation protocol (SIP), and a hypertext transfer protocol (HTTP).

8. A fast switching system for media source, comprising a multimedia server and a user equipment, wherein
the user equipment is adapted to generate request information for performing media source switching and send the request information to the multimedia server; and
the multimedia server is adapted to switch a current media source to a target media source requested by the user equipment according to the request information, and deliver the target media source to the user equipment through a current session and media communication channel resources.

9. The fast switching system for media source according to claim 8, wherein the user equipment comprises a request generating module and a request sending module;
the request generating module is adapted to generate the request information for performing media source switching of the user equipment by constructing an operation header field through a multimedia communication protocol; and
the request sending module is adapted to send the request information generated by the request generating module to the multimedia server.

10. The fast switching system for media source according to claim 8, wherein the multimedia server comprises a request receiving module, a media source switching module, and a media source information delivering module;
the request receiving module is adapted to receive the request information for performing media source switching from the user equipment;
the media source switching module is adapted to switch a current media source to a target media source requested by the user equipment according to the request information received by the request receiving module; and
the media source information delivering module is adapted to deliver the target media source switched by the media source switching module to the user equipment through a current session and media communication channel resources.

11. The fast switching system for media source according to claim 10, wherein the multimedia server further comprises: a request determining module, adapted to determine whether the request information received by the request receiving module is valid or not, and notify the media source switching module to perform media source switching after determining that the request information is valid.

12. A multimedia server, comprising a request receiving module, a media source switching module, and a media source information delivering module, wherein
the request receiving module is adapted to receive request information for performing media source switching from a user equipment;
the media source switching module is adapted to switch a current media source to a target media source requested by the user equipment according to the request information received by the request receiving module; and
the media source information delivering module is adapted to deliver the target media source switched by the media source switching module to the user equipment through a current session and media communication channel resources.

13. The multimedia server according to claim 12, further comprising: a request determining module, adapted to determine whether the request information received by the request receiving module is valid or not, and notify the media source switching module to perform media source switching after determining that the request information is valid.

14. The multimedia server according to claim 13, wherein the request determining module comprises a current session determining sub-module, adapted to determine whether the current session corresponding to the request information exists or not, and the request information is determined as valid if the current session exists.

15. The multimedia server according to claim 13, wherein the request determining module comprises a target media source determining sub-module, adapted to determine whether the target media source requested to be switched to exists or not, and the request information is determined as valid if the target media source exists.

16. A user equipment, comprising a request generating module and a request sending module, wherein
the request generating module is adapted to generate request information for performing media source switching of the user equipment by constructing an operation header field through a multimedia communication protocol; and
the request sending module is adapted to send the request information generated by the request generating module to a multimedia server.
